(19) United States
(12) Patent Application Publication
(10) Pub. No.: US 2019/0225194 A1
(43) Pub. Date: Jul. 25, 2019

(54) DETECTION SYSTEM FOR A MOTOR VEHICLE

(71) Applicant: Valeo Systèmes d'Essuyage, Le Mesnil Saint Denis (FR)

(72) Inventors: Maxime Baudouin, Issoire (FR); Giuseppe Grasso, Issoire (FR); Grégory Kolanowski, Issoire (FR); Thibaud Passerieux, Issoire (FR); Philippe Picot, Issoire (FR); Jordan Vieille, Issoire (FR)

(73) Assignee: Valeo Systèmes d'Essuyage, Le Mesnil Saint Denis (FR)

(21) Appl. No.: 16/337,251

(22) PCT Filed: Aug. 24, 2017
(86) PCT No.: PCT/EP2017/071304

§ 371 Date: Mar. 27, 2019

(30) Foreign Application Priority Data
Sep. 28, 2016 (FR) 1659244

(51) Int. Cl. B60S 1/56; B60S 1/52; B08B 3/04; G01S 7/481; G01S 17/93; G02B 27/00

(52) U.S. Cl. CPC B60S 1/56; B60S 1/52; G02B 27/0006; G01S 7/4813; G01S 17/936; B08B 3/04

(57) ABSTRACT

The invention concerns a detection system (1) intended to equip a motor vehicle. This detection system (1) comprises at least one optical sensor (2) delimited by at least one optical surface (20), the shape and orientation of which define a detection field (21) of the optical sensor (2), and at least one cleaning device (3) for cleaning this optical surface (20). The cleaning device (3) comprises a delivery ramp (4) for delivering at least one cleaning and/or drying fluid, said delivery ramp (4) being movable, relative to the optical surface (20), between a first so-called rest position in which it does not deliver any fluid and a second position. According to the invention, in each position of the movement of same between the first and second positions, the delivery ramp (4) is situated outside the detection field (21) of the optical sensor (2).

The present invention relates to the domain of detection systems designed to be fitted to motor vehicles. The invention relates more specifically to a cleaning device for such a detection system.

The detection systems that are now fitted to a large number of motor vehicles are intended to compile information on the environment of the motor vehicle, notably in order to provide the driver with a driving aid and/or help when maneuvering the vehicle. For this purpose, the detection system is commonly installed on the vehicle such as to compile information on the front environment, on the rear environment or on the lateral environment of the vehicle. The detection system is therefore for example installed on the front face and/or on the rear face and/or on a rear-view mirror of the vehicle.

However, these locations are particularly exposed to dirt such as dirty water, dust and other types of projection. Such dirt constitutes an obstacle to the emission and reception of information and can adversely affect the operation of the detection system, or even make such operation impossible.

Recently, efforts have been made to fit motor vehicles with detection systems that target the road in front of the vehicle to analyze whether obstacles could cause accidents and to implement avoidance and/or emergency braking maneuvers accordingly. The need to keep the optical surface of these detection systems clean is the same as described above.

The optical surfaces of the detectors in such detection systems usually have complex shapes, notably having an emission zone for a detection signal and a receiving zone for this signal. This results in larger sizes than a camera lens for example, and as a result the related cleaning device is also a larger.

In the context of the present invention, the term optical sensor shall refer to any sensor, such as a camera, laser sensor or the like, based on the emission and/or detection of electromagnetic radiation, notably in the spectrum visible or invisible to the naked eye, in particular infrared. The term optical surface shall refer to a surface that is at least partially transparent to such radiation.

Such cleaning devices can notably include a delivery manifold provided with a plurality of delivery orifices delivering fluid over some or all of the dimension of the optical surface to be cleaned. This manifold can be arranged at the end of a conveyance member for cleaning and/or drying fluid(s) that is connected at the upstream end thereof to a fluid storage assembly.

The shape and size of the manifold can vary as a function of the optical surface to be cleaned. Accordingly, the length of the manifold can be varied to provide an appropriate number of delivery orifices and/or to provide a more or less straight manifold to adapt to the curvature of the optical surface.

The present invention relates to the context of cleaning optical sensors using a delivery manifold, and concerns a detection system designed to be fitted to a motor vehicle, this detection system having at least one optical sensor delimited by at least one optical surface of which the shape and orientation define a detection field of said optical sensor. The detection system according to the invention also includes at least one cleaning device for cleaning this optical surface, this cleaning device notably including a delivery manifold for at least one cleaning and/or drying fluid. In the detection system according to the invention, this delivery manifold is moveable, in relation to the optical surface, between a first position referred to as the idle position, in which said delivery manifold delivers no fluid, and a second position. According to the invention, the delivery manifold is outside the detection field of the optical sensor in all of the positions of the delivery manifold between the first and second positions.

Advantageously, the delivery manifold is arranged at one end of a conveyance member for one or more cleaning and/or drying fluids of the cleaning device for the detection system. This conveyance member advantageously has an elongate shape along a longitudinal lengthwise axis. According to the invention, the direction in which the delivery manifold moves between the first position thereof (or idle position) and the second position thereof is advantageously substantially parallel to the direction of the lengthwise axis of the conveyance member of the cleaning device.

According to one feature of the invention, the delivery manifold has a plurality of fluid delivery orifices that are designed to enable one or more cleaning and/or drying fluids to be projected onto the optical surface of the optical sensor. Advantageously, these delivery orifices are arranged to open out firstly on the outside of the manifold and secondly on a delivery channel arranged inside the delivery manifold. Furthermore, these delivery orifices extend on both sides of the lengthwise axis of the conveyance member at the end of which the delivery manifold is arranged, in a direction substantially perpendicular to the direction of this lengthwise axis. More specifically, the delivery manifold can have an axial plane of symmetry containing the lengthwise axis of the conveyance member. The delivery manifold and the cleaning device as a whole can be arranged such that the axial plane of symmetry of the delivery manifold coincides with the axial plane of symmetry of the optical surface.

The delivery manifold has a first end portion that is attached to the conveyance member and a second portion containing the delivery channel and the delivery orifices.

According to the invention, when the delivery manifold is in the first position, as specified above, the delivery manifold is outside the detection field of the optical sensor. However, in this first position, referred to as the idle position, no cleaning and/or drying fluid is delivered by the delivery orifices arranged therein. The delivery of such fluids is only permitted, according to the invention, when the delivery manifold is in an intermediate position, i.e. a position located between the first position and a second position. The second position is in particular an end deployed position in which fluid delivery is notably also permitted. This can for example be achieved by implementing one or more telescopic pistons carrying this delivery manifold, fitted with one or more seals and designed to slide, during movement of the delivery manifold, inside a supply channel such that, depending on the relative position thereof in relation to the portion of the supply channel in which said pistons are sliding, the seals carried on the pistons seal or do not seal this channel, thereby enabling or preventing fluid passage and the conveyance thereof to the delivery manifold and to the delivery orifices arranged therein. Advantageously, these pistons and seals are designed to enable fluid passage when the delivery manifold moves to an intermediate position, that is not the idle position. According to different variant embodiments, these pistons and seals can be designed to enable fluid passage from a predetermined relative position of the delivery manifold and of the optical surface.

In other words, the cleaning device of the detection system according to the invention includes a telescopic delivery manifold that is designed not to project any fluid when the delivery manifold is in the first position, or the idle position, and to project fluid onto the optical surface once the delivery manifold has moved from this first position or once the delivery manifold has reached a predetermined intermediate position when moving between the first position and the second end deployed position.

According to another feature of the invention, the delivery manifold moves between the first position and the second position in a direction substantially parallel to the optical axis of the optical surface, notably moving away from this latter.

According to a particular embodiment of the invention, the delivery manifold is curved. This embodiment is particularly advantageous where the optical sensor implemented in the detection system has a curved optical surface. This is the case, for example, where the sensor used in the detection system is a laser sensor. In this case, the invention provides for the curvature of the delivery manifold to be equal to or substantially equal to the curvature of the optical surface of the sensor.

More specifically, where the optical surface has a substantially cylindrical overall shape, the invention provides for the delivery manifold to also have a substantially cylindrical envelope curve in which the generators are substantially parallel to the generators of the curved shape of the optical surface.

According to one feature of the invention, the outer surface of the sensor has at least one first emitter portion through which an outgoing signal is emitted, and/or at least one second receiver portion through which an incoming signal is received. For example, the incoming signal is the outgoing signal sent back by the environment of the vehicle. This is notably the case when the sensor implemented in the detection system is an optical sensor, notably a laser such as a LIDAR or analog laser.

Thus, a sensor with just one emitter portion or just one receiver portion may be used, in which case the optical detection system has at least two sensors of different types to perform the emission and reception functions respectively. Alternatively, a sensor with both emitter and receiver portions can be used.

In the latter case, the emitter portion and the receiver portion can thus form either a single continuous optical surface or distinct convergent zones, thus forming an optical surface comprising, for example, a first band and a second band that are inclined at different angles and that notably share a common edge.

Where the emitter portion and the receiver portion form one single continuous optical surface, the invention provides for the delivery manifold to have a curvature that is equal to the overall curvature of the continuous optical surface. Where the optical surface has an emitter portion and a receiver portion forming distinct convergent zones, the invention can provide for the delivery manifold to have a curved envelope in which the curvature, according to different variant embodiments, is equal to the curvature of the emitter portion, or equal to the curvature of the receiver portion, or equal to the mean curvature defined by the curved shapes of the emitter portion and of the receiver portion respectively. In this case, it should be noted that, since the cleanliness of the emitter portion is a key point in the efficiency of the detection system, it could be advantageous for the delivery manifold to have a curved shape in which the curvature is equal to the curvature of the curved shape of said emitter portion.

Advantageously, regardless of whether the delivery manifold is curved or otherwise, the delivery manifold, and notably the second portion thereof in which the channel and the delivery orifices are arranged, forms a substantially continuous surface with the optical surface of the optical sensor when the delivery manifold is in the first position (or idle position).

Advantageously, the invention provides for the delivery manifold to be positioned, in relation to the optical surface and to the detection field thereof, on one side of this optical surface, notably in a plane parallel to the plane containing the curve of the delivery manifold.

Advantageously, the conveyance member is attached to a housing of the optical sensor. The delivery manifold is therefore advantageously linked, via the conveyance member attached thereto, to such a housing. More generally, the invention provides for the position of the conveyance member to be stable relative to the optical surface. In other words, the conveyance member and the delivery manifold are advantageously arranged according to a predetermined orientation facing the optical surface to be cleaned.

According to specific features of the invention, where the optical surface has an emitter portion and a receiver portion, the conveyance member is attached to a receiving face of the housing and this receiving face extends from an edge of the emitter portion. The delivery manifold, when in the first position, is positioned close to at least one emitter portion. This ensures that the first jets of fluid onto the surface of the optical sensor are directed directly onto the emitter portion, which is the portion of the sensor that requires optimal cleaning.

The invention also covers a method for cleaning and/or drying an optical surface of an optical sensor of a detection system such as the one described above. Such a method can notably include the different regions of the optical surface being reached successively by the delivery manifold as the delivery manifold moves between the first position and the second position thereof.

Other features, details and advantages of the invention and operation thereof are set out more clearly in the description given below by way of example and in relation to the attached figures, in which:

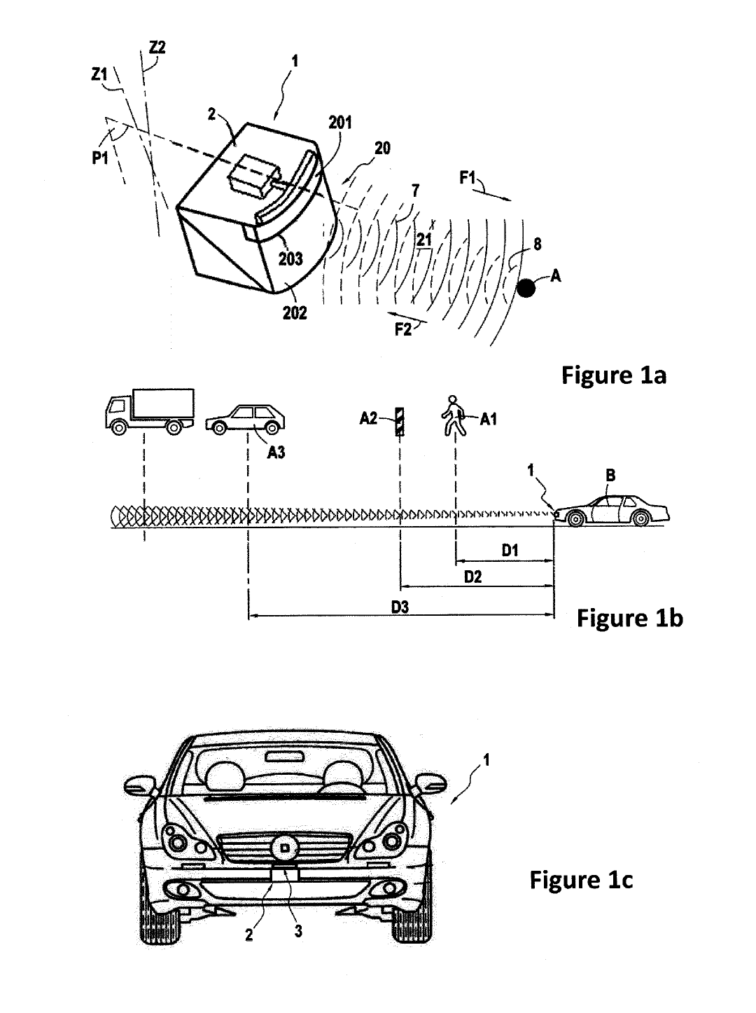

FIGS. 1a to 1c are general schematic views showing respectively the operating principle of a detection system of the type more specifically concerned by the invention, the different uses of such a system for detecting persons, objects or other vehicles on the road, and an example implementation of such a system in a motor vehicle,

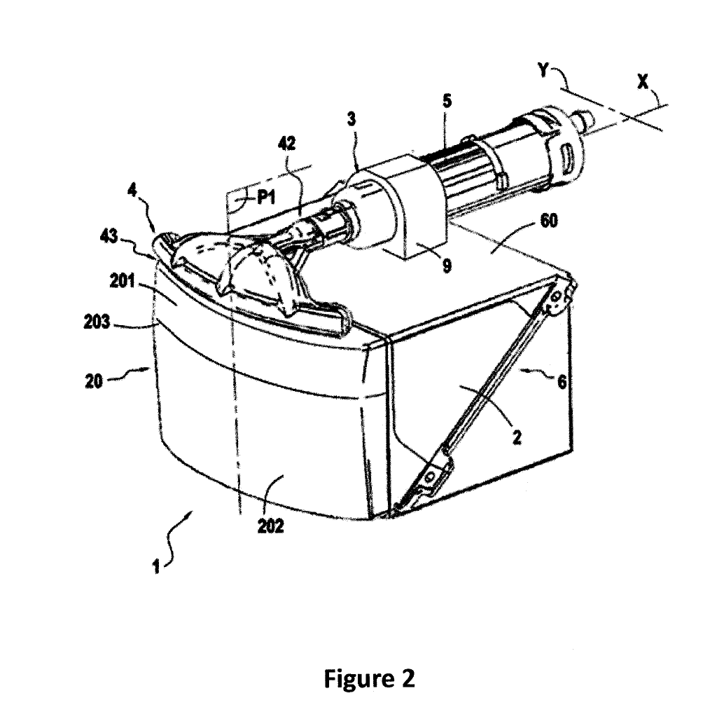

FIG. 2 is a schematic perspective view of a detection system according to the invention in which the delivery manifold of the cleaning device is in the first position, or idle position,

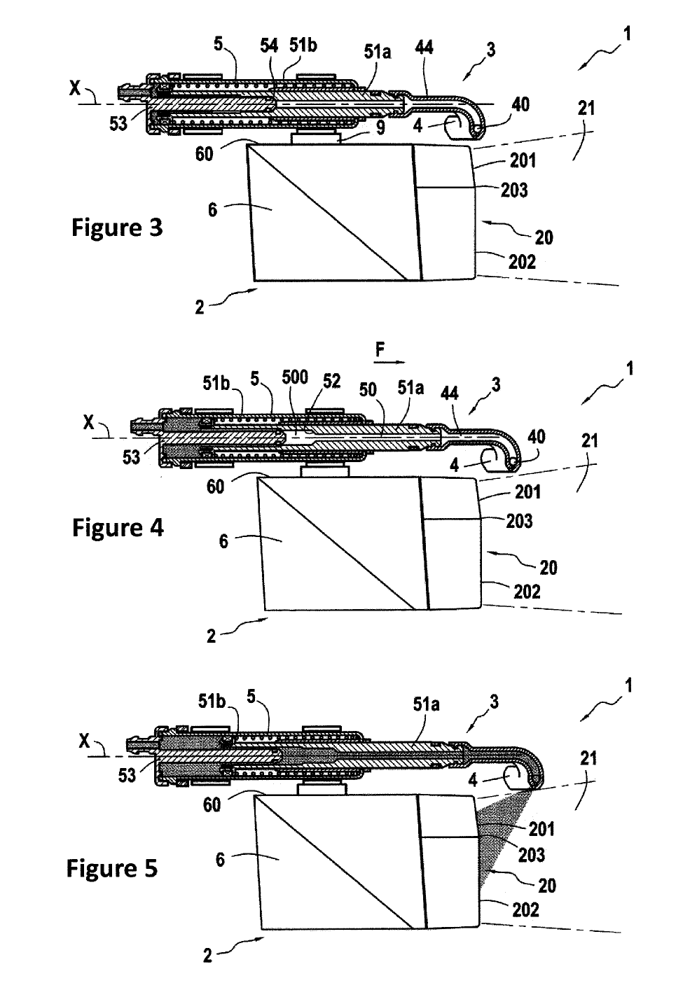

FIG. 3 is a schematic cross-section view of a detection system according to the invention in which the delivery manifold of the cleaning device is in the first position, or idle position,

FIG. 4 is a schematic cross-section view of a detection system according to the invention in which the delivery manifold of the cleaning device is in an intermediate position between the first position in FIG. 3 and a second position,

FIG. 5 is a schematic cross-section view of a detection system according to the invention in which the delivery manifold of the cleaning device is in the second position,

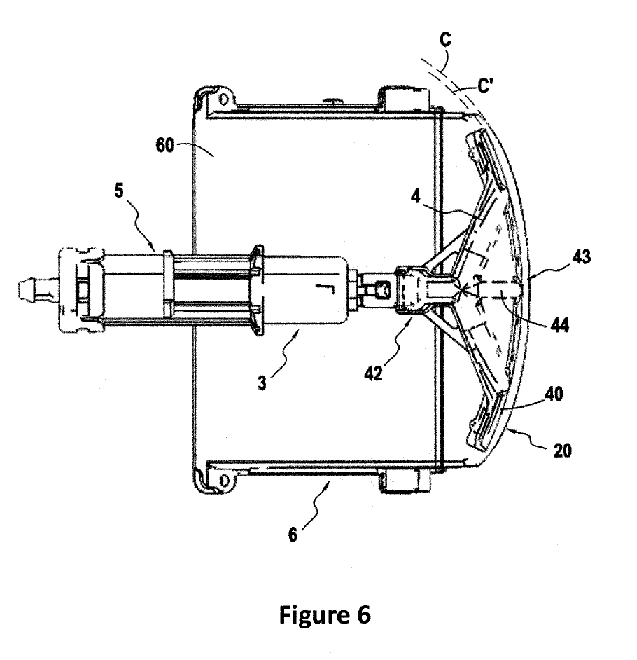

FIG. 6 is a top view of the detection system in FIG. 2, and

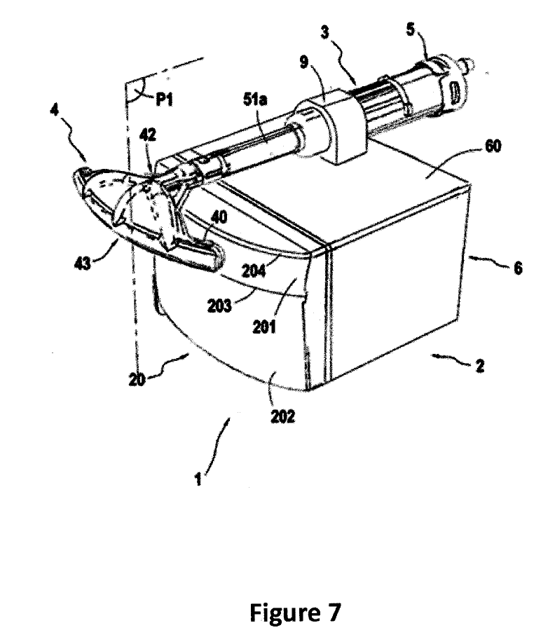

FIG. 7 is a schematic perspective view of a detection system according to the invention in which the delivery manifold of the cleaning device is in the second position.

It should first be noted that whereas the figures show the invention in detail to enable the invention to be carried out, these figures may naturally be used to better define the invention where appropriate. It should also be borne in mind that the same elements are identified using the same reference signs in all of the figures.

It should also be borne in mind that, in the following description, the terms “upstream” and “downstream” refer to the direction of flow of the cleaning and drying fluids in the cleaning device of the detection system according to the invention. Furthermore, the term “upstream” refers to the side of the cleaning device into which these cleaning and drying fluids are admitted, and the term “downstream” refers to the side of the cleaning device out of which the cleaning and drying fluids are delivered towards the optical surface of a detection system of a motor vehicle.

The figures together show a particularly advantageous embodiment of a detection system 1 according to the invention. According to this embodiment, the detection system 1 is notably delimited buy an optical surface 20 of an optical sensor 2 included therein. The optical surface has at least one emitter portion and at least one receiver portion. In the example shown, the optical surface 20 has two distinct portions, specifically a first emitter portion 201 and a second receiver portion 202. The emitter portion 201 and the receiver portion 202 of the optical surface 20 are in this case curved and each one has a substantially cylindrical envelope surface. The emitter portion 201 and the receiver portion 202 are in this case distinct and convergent, such that the optical surface 20 is formed by a first band corresponding to the emitter portion 201 and a second band corresponding to the receiver portion 202. These two bands share a common edge 203.

According to this embodiment of the invention, the detection system 1 has an axial plane of symmetry P1 passing through the axes of curvature of the emitter portion 201 and of the receiver portion 202. The common edge 203 shared by the emitter portion 201 and the receiver portion 202 in particular intersects the axial plane of symmetry P1 in a perpendicular direction. The shapes and dimensions respectively of the emitter portion 201 and of the receiver portion 202 or, more generally, of the optical surface 20, define a detection field 21 of the optical sensor 2. This detection field 21 is defined as the solid angle in which an object A can be reached by the outgoing signal 7 emitted by the emitter portion 201 such that the incoming signal 8 returned by said object A is received by the receiver portion 202 of the optical surface 20.

FIG. 1a shows operation of such a detection system 1 and the related FIG. 1b shows the different usage options thereof. An outgoing optical signal 7, shown by the concentric forms illustrated with unbroken lines in FIG. 1, is emitted by the emitter portion 201 in the general direction shown by the arrow F1. If this signal encounters an object A located in the signal path, the signal is returned by this object A as an incoming optical signal 8, shown by the concentric forms illustrated using dashed lines in FIG. 1. This incoming optical signal 8 is returned, in the general direction shown by the arrow F2, towards the receiver portion 202 of the detection system 1. The outgoing signal 7 and the incoming signal 8 are then compared using analysis means configured in the detection system 1 to deduce information concerning the shape and position of the object A.

Thus, as shown in FIG. 1a, such a detection system 1, for example position at the front of a vehicle B, can provide the driver of said vehicle B with information relating, for example, both to the nature of and the distance separating the vehicle B from different types of objects found in the detection field 21 of the optical sensor 2: a pedestrian A1 located at a distance D1 from the vehicle B, a road sign A2 located at a distance D2, other vehicle(s) A3 located at a distance D3, etc.

FIG. 1c also shows a view of a motor vehicle on which such an optical-sensor detection assembly 1 is mounted, notably in this case on the front face, enabling obstacles on the road in front of the vehicle to be detected, as shown in FIG. 1b.

It is easy to understand that the quality of the outgoing signal 7 and the incoming signal 8 is essential to the correct and reliable operation of the detection system 1. The cleanliness of the emitter portion 201 and of the receiver portion 202 is notably a key element in the quality of the signals emitted and/or received by the optical surface 20. It is therefore essential to have a cleaning device 3 that enables the emitter portion 201 and the receiver portion 202 of the optical surface 20, or more generally the optical surface 20, to be kept clean over the entire detection field 21 of the optical sensor 2.

Such a cleaning device 3 is shown in FIGS. 2 to 7. With reference to these figures, the cleaning device 3 has a delivery manifold 4 designed to enable one or more cleaning and/or drying fluid to be projected onto the optical surface 20 to be cleaned. For this purpose and as shown in FIGS. 3, 4 and 5, the delivery manifold 4 has for example at least one delivery channel 40 in which are arranged a plurality of delivery orifices 41 through which the cleaning and/or drying fluid or fluids are projected onto the optical surface 20. In the detection system 1 according to the invention, the delivery manifold 4 can be moved between a first position or idle position, shown more specifically in FIGS. 2, 3 and 6, and a second position or end deployed position, shown more specifically in FIGS. 5 and 7, an intermediate position between these two positions being shown in FIG. 4.

According to the embodiment of the invention shown in the figures, the delivery manifold 4 is curved. More specifically and as shown particularly in FIG. 6, the delivery manifold 4 has a curvature C′ that is substantially equal to the curvature C of the optical surface 20. According to the embodiment of the invention shown more specifically in the figures, since the curvatures of the optical surface 20 differ between the emitter portion 201 and the receiver portion 202 thereof, the curvature of the delivery manifold 4 is substantially equal to the curvature of the emitter portion 201, as shown in particular in FIG. 6.

The invention is not limited to a specific curvature of the surface to be cleaned. Said curvature may have a complex shape.

According to the invention, the delivery manifold 4 Is arranged in relation to the optical surface 20 such that the delivery manifold is outside the detection field 21 of the optical sensor 2 in all of the positions of the delivery manifold between the first and second positions. This is notably made possible both by the particular shape of the delivery manifold 4 and by the spatial layout thereof relative to the optical surface 20, as detailed below.

The cleaning device 3 also includes a conveyance member 5 for the cleaning and/or drying fluid or fluids. The conveyance member 5 has an elongate shape along an lengthwise axis X. According to the embodiment of the invention more specifically illustrated in the figures, the overall envelope shape of the conveyance member 5 is substantially cylindrical about the axis X. At the upstream end thereof, the conveyance member 5 is linked to a cleaning and/or drying fluid feed assembly, not shown in the figures. This feed assembly comprises, for example, a fluid storage tank and one or more channels linking a storage tank to the conveyance member 5. At the downstream end thereof, the conveyance member 5 is attached to the delivery manifold 4. More specifically and according to the embodiment of the invention more specifically illustrated in the figures, the conveyance member 5 is attached at the downstream end thereof to an end portion 42 of the delivery manifold 4 having an elongate shape along the lengthwise axis X. In other words, the delivery manifold 4 is in this case attached to the conveyance member 5 by an end portion 42 that extends said conveyance member 5 coaxially. Thus, at the upstream end thereof, the delivery manifold 4 is attached to the conveyance member 5 by the end portion 42 thereof and, at the downstream end thereof, has a second curved portion 43 having a curvature similar to the curvature of the emitter portion 201 of the optical surface 20, the delivery orifices 41 being arranged in said curved portion 43. According to the invention, the delivery manifold 4 moves between the first or idle position thereof and the second position thereof in a direction parallel to the direction of the lengthwise axis X.

Advantageously, the delivery manifold 4 is attached to the conveyance member 5 such that the curved portion 43 thereof extends on both sides of the downstream end of the conveyance member 5 in a direction transverse to the lengthwise axis X thereof. More specifically and according to the embodiments shown in the figures, this curved portion 43 is substantially symmetrical about the transverse direction Y intersecting the lengthwise axis X in a perpendicular direction, on both sides of the downstream end of the conveyance member 5.

Advantageously and as shown in FIGS. 2 to 7, the conveyance member 5 is attached to a housing 6 notably for the optical sensor 2 of the detection system 1. More specifically and according to the embodiment shown more specifically in the figures, the conveyance member 5 is attached using appropriate attachment means 9 to a receiving face 60 of the housing 6. It should be noted that, according to different embodiments, the housing 6 can be a housing for the whole of the detection system 1 or for the optical sensor 2 only. According to the invention, the receiving face 60 is substantially perpendicular to the optical surface 20 and extends from this latter. According to the embodiment illustrated in the figures, this receiving face 60 is also substantially perpendicular to the axial plane of symmetry P1 defined above. More specifically and according to this specific embodiment, the intersection edge of the receiving face 60 with the optical surface 20 is an edge of the emitter portion 201, and more specifically the edge 204 opposite the common edge 203 that this emitter portion 201 shares with the receiver portion 202. According to this embodiment, the conveyance member 5 is arranged on the receiving face 60 such that the lengthwise axis X thereof is both substantially parallel to the receiving face 60 and within the axial plane of symmetry P1 defined above.

Consequently, since the delivery manifold 4 moves between the first or idle position thereof and the second position thereof in a direction substantially parallel to the direction of the lengthwise axis X, this movement occurs in the axial plane of symmetry P1, which is substantially perpendicular to the optical surface 20. In other words, this movement occurs parallel to the optical axis of the sensor.

Also as result of the foregoing, the delivery manifold 4, regardless of the position thereof between the idle position thereof and the second position thereof, is located on the side of the receiving face 60 of the housing 6 opposite the optical surface 20.

FIGS. 3 to 5 show the detection system 1 according to the invention with the delivery manifold 4 in different positions in relation to the optical surface 20, i.e. with the delivery manifold in different positions during movement thereof between the first or idle position, as shown in FIG. 3, and the second end deployed position thereof, as shown in FIG. 5.

These schematic cross-section views taken along a plane substantially parallel to the axial plane of symmetry P1 defined above show the cleaning and/or drying fluid injection assembly of the cleaning device 3. The fluid injection assembly of the cleaning device 3 includes a conveyance channel 50 arranged in the conveyance member substantially coaxially with the lengthwise axis X thereof. More specifically, the conveyance channel 50 is drilled in a male portion 51a that is designed to slide in the direction of this lengthwise axis X in a female portion 51b of said conveyance member 5 forming the body of the cylinder. The male portion 51a, forming a piston that can move inside the cylinder, is the portion that is attached to the delivery manifold 4 at the downstream end thereof. Inside the delivery manifold 4, the conveyance channel 50 is extended substantially coaxially by at least one distribution channel 44 that opens out into the delivery channel 40. Downstream, the conveyance channel 50 forms the downstream extension of a supply channel 500 of greater diameter, with which same is coaxial along the lengthwise axis X. At the intersection therebetween, the conveyance channel 50 and the supply channel 500 form a shoulder 52.

The injection assembly also has a rod 53 with a lengthwise axis X about which the male portion 51a forming a piston is designed to slide. The rod 53 is provided with a peripheral gasket 54, for example an O-ring, that seals the sliding of the piston about the rod. The piston and/or the rod are provided with grooves that enable fluid to pass from an admission chamber arranged upstream of the male portion to the supply channel, once the relative position of the rod in relation to the piston enables the fluid not to be blocked by the seal by passing through the grooves.

The fluid injection assembly of the cleaning device of the detection system 1 according to the invention works as follows.

When the delivery manifold is in the first or idle position thereof, as shown in FIGS. 2 and 3, the relative position of the rod 53 in relation to the mobile piston 51a is such that the rod 53 and the peripheral gasket 54 block the supply channel 500. As a result, no fluid can flow through this supply channel 500 to the conveyance channel 50 and, via the distribution channel 44, to the delivery channel 40 arranged in the delivery manifold 4. Consequently, no fluid is projected onto the optical surface 20.

In this first or idle position, the delivery manifold 4 is arranged in relation to the conveyance member 5 and the optical surface 20 such that the curved portion 43 thereof forms a substantially continuous surface with said optical surface 20. More specifically, in this first position, the curved portion 43 of the delivery manifold 4, which is positioned on the side of the receiving face 60 of the housing 6 opposite the optical surface 20 as mentioned above, is positioned close to the emitter portion 201 of this optical surface 20, in the vicinity thereof to form a substantially continuous surface therewith.

FIG. 4 shows the detection system 1 according to the invention in an intermediate position of the delivery manifold 4 between the first position and the second position thereof. In this intermediate position, the fluid injected into the conveyance member pushes the male portion 51a of the conveyance member 5, against the return force of a spring seated in the conveyance member, substantially parallel to the lengthwise axis X and in the direction shown by the arrow F in FIG. 4. This movement causes a relative sliding of the rod 53 in relation to this male portion 51a. However, in this intermediate position, the peripheral gasket 54 continues to prevent the fluid from entering the supply channel 500, this gasket still being arranged downstream of the end of the slots formed between the piston and the rod.

By sliding downstream, the male portion 51a of the conveyance member 5 causes the delivery manifold 4 to slide in the same direction, i.e. away from the optical surface 20. As shown in FIG. 4, the delivery manifold is arranged on the side of the receiving face 60 such that the delivery manifold remains outside the detection field 21 of the optical sensor 2.

This movement continues as long as the fluid is being injected into the conveyance member or, according to specific variant embodiments, until the delivery manifold 4 or the male portion 51 of the conveyance member 5 reaches a mechanical stop previously arranged for example on the receiving face 60 of the housing 6. This end position is in this case the second position of the delivery manifold 4 shown in FIG. 5, in which the delivery manifold 4 is entirely deployed in relation to the optical surface 20, and farthest therefrom. This second position is more specifically shown in FIGS. 5 and 7. It should be noted that the delivery manifold 4 is also designed to remain outside the detection field 21 of the optical sensor 2 in this case.

The invention therefore makes it possible to effectively clean the optical surface 20 of the optical sensor 2 without the delivery manifold 4 through which the cleaning and/or drying fluid or fluids are projected onto this optical surface 20 ever being in the detection field 21 of the optical sensor 2. This in particular makes it possible to perform cleaning operations when the vehicle is moving and the related detection system is in operation.

The fact that the delivery manifold is not in the detection field of the optical sensor is made possible firstly by the very shape of the delivery manifold and secondly by the specific arrangement thereof on the side of the receiving face 60 of the housing 6, this arrangement enabling said delivery manifold 4 to move between the first or idle position and the second fully deployed position thereof opposite the optical surface 20 in a direction substantially perpendicular to the direction of this optical surface 20, in the axial plane of symmetry. Alternatively, the fluid injection assembly of the cleaning device 3 is designed such that the fluid injection into the delivery manifold 4, and therefore the fluid projection onto the optical surface 20, is not limited to an interval between an intermediate position and the second position, but is permitted substantially once the delivery manifold 4 has left the first or idle position thereof.

However, the invention is not limited to the means and arrangements described and illustrated, but also applies to any equivalent means or arrangements and any combination of such means. In particular, although the invention has been described here in an embodiment in which the overall shape of the conveyance member 5 is cylindrical, the invention naturally applies to all geometries and shapes provided that the elements performing the different functions described herein are present. Moreover, whereas the invention is described herein in an embodiment in which the conveyance member 5 is attached to the receiving face 60 of the housing 6 and directly attached to the delivery manifold 4, the invention also applies more generally where the conveyance member 5 is positioned in a relative position that is stable in relation to the optical surface 2 and linked using appropriate means to the delivery manifold 4 designed as described in this document.

Furthermore, whereas the invention has been described here in an embodiment in which fluid delivery is authorized once the delivery manifold 4 leaves the first or idle position thereof, it is entirely possible for fluid delivery to be authorized once the delivery manifold 4 has reached a predetermined trigger position in relation to the optical surface 20, without thereby adversely affecting the invention. Furthermore, the invention applies to embodiments in which the fluid is delivered continuously during movement of the delivery manifold 4 in relation to the optical surface, as well as to embodiments in which fluid delivery is authorized for certain number of relative predefined positions of the delivery manifold 4 in relation to the optical surface.

Finally, whereas the fluid injection assembly described in the present document enables the desired functions to be performed while occupying the least possible space, the invention applies to any type of fluid injection assembly enabling performance of the desired functions described in the present document for the cleaning device.

1. A detection system to be fitted to a motor vehicle, the detection system, comprising:
at least one optical sensor delimited by at least one optical surface, the optical surface having a shape and an orientation defining a detection field of the optical sensor; and
at least one cleaning device for this optical surface,
wherein the cleaning device has a delivery manifold for delivering at least one cleaning and/or drying fluid,
said delivery manifold being movable, relative to the optical surface, between a first or idle position in which the delivery manifold does not deliver any fluid and a second position,
wherein the delivery manifold is outside the detection field of the optical sensor in all of the positions of the delivery manifold between the first and second positions.

2. The detection system as claimed in claim 1, wherein the delivery manifold has a plurality of fluid delivery orifices.

3. The detection system as claimed in claim 1, wherein the delivery manifold moves substantially perpendicular to the optical surface away from this latter, between the first and second positions.

4. The detection system as claimed in claim 1, in which the optical surface of the optical sensor is curved and the delivery manifold is curved.

5. The detection system as claimed in claim 4, wherein the curvature of the delivery manifold is equal to the curvature of the optical surface.

6. The detection system as claimed in claim 4, wherein the delivery manifold is arranged on one side of a housing for the optical sensor arranged in a plane parallel to the plane containing the curvature of the delivery manifold.

7. The detection system as claimed in claim 1 wherein, in the first position thereof, referred to as the idle position, the delivery manifold forms a substantially continuous surface with the optical surface.

8. The detection system as claimed in claim 1 wherein the delivery manifold is linked to a conveyance member attached to a housing of the optical sensor.

9. The detection system as claimed in claim 8, wherein the position of the conveyance member is stable relative to the optical surface.

10. The detection system as claimed in claim 1, wherein the optical surface has at least one emitter portion and/or one receiver portion.

11. The detection system as claimed in claim 8, wherein the optical surface has an emitter portion and a receiver portion and the conveyance member is attached to a receiving face of the housing that extends from an edge of the emitter portion.

12. The detection system as claimed in claim 10, wherein the delivery manifold, when in the first position, is positioned close to at least one emitter portion.

13. (canceled)
